(19) United States
(12) Patent Application Publication
(10) Pub. No.: US 2003/0150784 A1
(43) Pub. Date: Aug. 14, 2003

(54) Liquid chlorine injection device

(76) Inventors: Michael Steven Georgia, Rhome, TX (US); Burke Scott Husberg, Rhome, TX (US); Roy J. T. Harris, Rhome, TX (US)

Correspondence Address: Clinton R. Stuart, P.O. Box 4412, Baton Rouge, LA, 70821-4412, US

(21) Appl. No.: 10/328,549

(22) Filed: Dec. 23, 2002

Related U.S. Application Data
(60) Provisional application No. 60/344,926, filed on Dec. 21, 2001.

(51) Int. Cl. C02F 1/00

(52) U.S. Cl. 210/97

(57) ABSTRACT

The present invention is a Liquid Chlorine Injection Device (“LCID”) that is used in conjunction with a separate sewage treatment device to disinfect treated sewage effluent prior to discharge to ground. LCID basically comprises a vessel for containing liquid disinfectant, such as household chlorine bleach, a pumping mechanism, and a control mechanism. The control mechanism senses whether the effluent in the pump tank of a sewage treatment plant needs additional disinfectant, and if so, it activates the pumping mechanism. The pumping mechanism draws liquid disinfectant from the vessel and injects it into the pump tank until the proper disinfectant level is attained within the pump tank. LCID may also include liquid level sensors within the vessel, which notify the owner whenever additional liquid disinfectant needs to be added to the system.

### BACKGROUND OF THE INVENTION

This invention relates generally to the treatment of sewage. More particularly, this invention relates to the treatment of sewage discharged from houses and other buildings that are not connected to a municipal sewer system after the sewage has already been processed by a sewage treatment plant such that, after the sewage has been treated by the liquid chlorine injection device (“LCID”), it has been disinfected and is acceptable for discharge directly into the environment. Buildings that are not located on sewer lines often make use of sewage treatment plants to clean waste water before discharge to ground. Such waste water plants enable sewage effluent to be discharged directly to ground, rather than being stored in a septic tank system, which must be routinely pumped clean by a disposal company, without harming the environment or causing health concerns. State regulations govern environmental discharge levels from these types of sewage treatment plants. An example of such a typical sewage treatment plant may be found in U.S. Pat. No. 6,200,472.

Often these sewage treatment plants include a pump tank, as does the plant in U.S. Pat. No. 6,200,472. The pump tank stores the effluent for discharge until some triggering event occurs, and then the cleaned effluent is typically pumped to ground. The cleaned effluent from a pump tank may even be connected to a sprinkler system and used to water the lawn of the property at issue. This sewage effluent discharge process is improved if the effluent is disinfected prior to discharge, since the presence of a disinfectant ensures that harmful microorganisms are not released into the environment. The current method for disinfecting effluent utilizes chlorine tablets. The effluent basically flows over a chlorine tablet, so that the effluent is chlorinated and, thereby, disinfected. An example of such a chlorine tablet disinfectant system is shown in U.S. Pat. No. 6,281,802. Chlorine tablets are expensive, however, and there is no good way to easily notify the operator when the chlorine tablet has dissolved and is no longer effectively disinfecting the effluent.

The present invention of the LCID provides an alternative to chlorine tablet disinfectant devices. It utilizes common household bleach as its disinfectant material, thus providing equivalent chlorination ability at a much lower cost. LCID accomplishes its disinfecting function by periodically micro-dosing the effluent in the pump tank of a sewage treatment plant with liquid chlorine bleach. It uses a readily available and inexpensive consumable disinfectant (i.e. liquid bleach) in place of the costly chlorine tablets used in conventional systems, allowing users to realize substantial cost savings. It also provides a sensing and alarm mechanism that warns the user when liquid chlorine levels are running low. Thus, LCID represents a significant improvement over standard chlorine disinfectant systems used with residential-type sewage treatment plants.

### SUMMARY OF THE INVENTION

The Liquid Chlorine Injection Device (“LCID”) basically comprises a storage vessel for containing the liquid disinfectant, a pumping/discharge mechanism, and a control mechanism. The vessel is an impermeable container for storing liquid disinfectant, with a bottom, a top, and side walls that completely enclose a storage space. Although several locations for the storage vessel relative to the pump tank of the sewage treatment plant at issue are permissible, typically, it is located atop the pump tank of the sewage treatment plant for convenience. In the preferred embodiment, the vessel is comprised of fibreglass, and is sized so that it holds a sufficient amount of liquid disinfectant to treat effluent in the pump tank of the relevant sewage treatment plant for several weeks. Typically, a fill spout with a removable cap is located in the top of the vessel, allowing users to easily pour additional liquid disinfectant into the storage space of the vessel. And in the preferred embodiment, a separate subcompartment is built into the bottom of the vessel, providing a space to house the pumping/discharge mechanism.

The control mechanism preferably comprises a computer with a control panel and software, or some other type of electronic circuit, and a sensor. The sensor is preferably a time delay circuit, either fixed or variable, that triggers the release of the micro-doses of liquid disinfectant. The preferred embodiment of LCID uses commonly available household liquid chlorine bleach as the liquid disinfectant of choice.

LCID may also include, as an optional element, a liquid level sensor-alarm for sensing the level of the liquid disinfectant within the vessel of the LCID and activating an alarm that indicates when the vessel needs to be refilled. The preferred embodiment uses two reed switch sensors to accomplish this, typically in conjunction with an audible and/or visual alarm. The first reed switch is set to sound an alert whenever the level of liquid disinfectant in the vessel of the LCID falls beneath the pre-set low condition mark. The second reed switch generally is set to indicate that the vessel is completely empty, and that the liquid disinfectant has run out and must be replaced. It also typically deactivates the pump in the pump tank of the sewage treatment plant to which the LCID is attached, ensuring that there is no discharge of dangerous effluent to ground. The second reed switch sensor could also be connected to a central monitoring station, for example by modem, so that if the user employs a monitoring service for a monthly fee, the monitoring service would be notified and could respond as directed under the monitoring plan arrangement.

It is an object of this invention to disinfect sewage effluent prior to discharge. It is still another object of this invention to disinfect effluent in a pump tank in a more cost effective manner than available using chlorine tablets. It is yet another object of this invention to disinfect effluent using household liquid chlorine bleach. It is yet another object of this invention to monitor the liquid disinfectant level available, to ensure that adequate disinfectant is present. It is yet another object of this invention to alert the user when liquid disinfectant levels reach a low condition. It is yet another object of this invention to prevent discharge of effluent to ground if it is not properly disinfected. These and other objects will be apparent to those skilled in the art field.

### BRIEF DESCRIPTION OF DRAWINGS

Reference will be made to the drawings, where like parts are designated with like numerals and wherein:

FIG. 1 illustrates the preferred embodiment of the LCID located atop a pump tank of a sewage treatment plant;

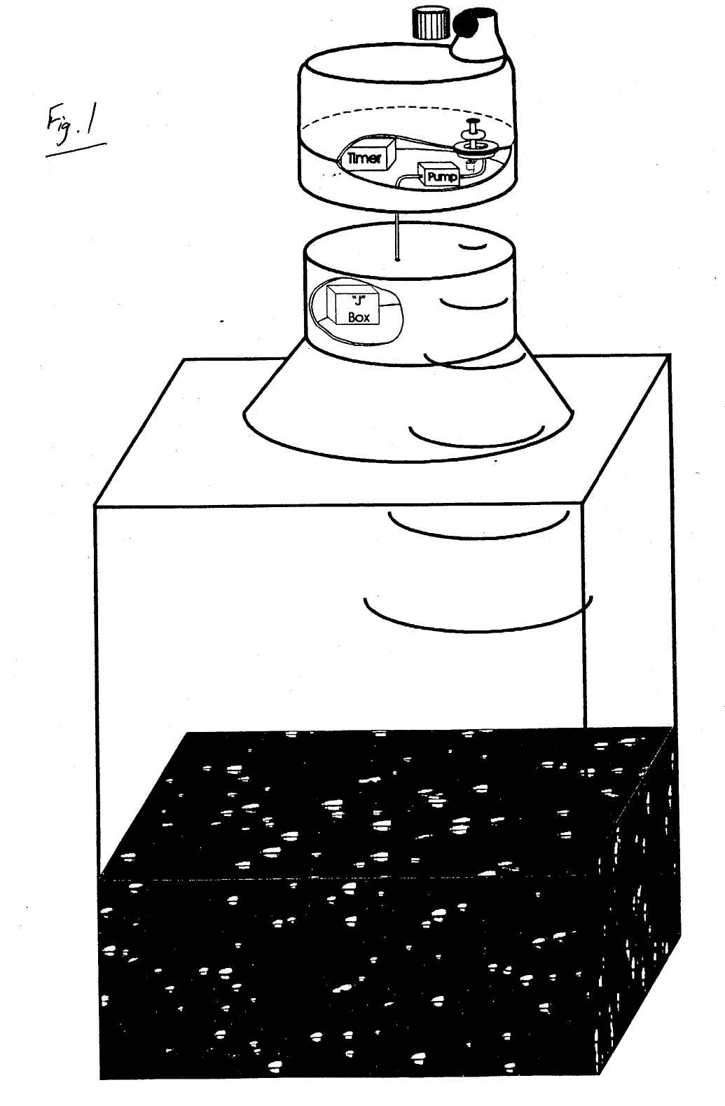

FIG. 2 illustrates the preferred embodiment of the reed switch sensors of the LCID; and

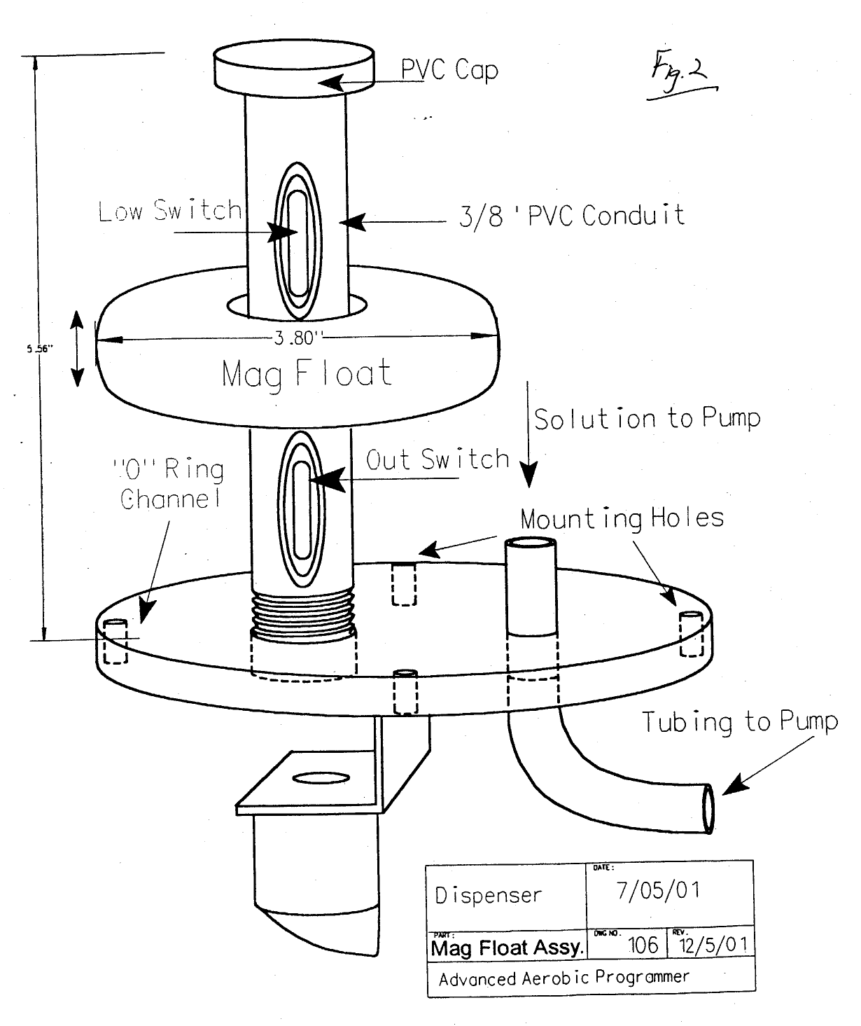

FIG. 3 illustrates the preferred embodiment of the vessel of the LCID.

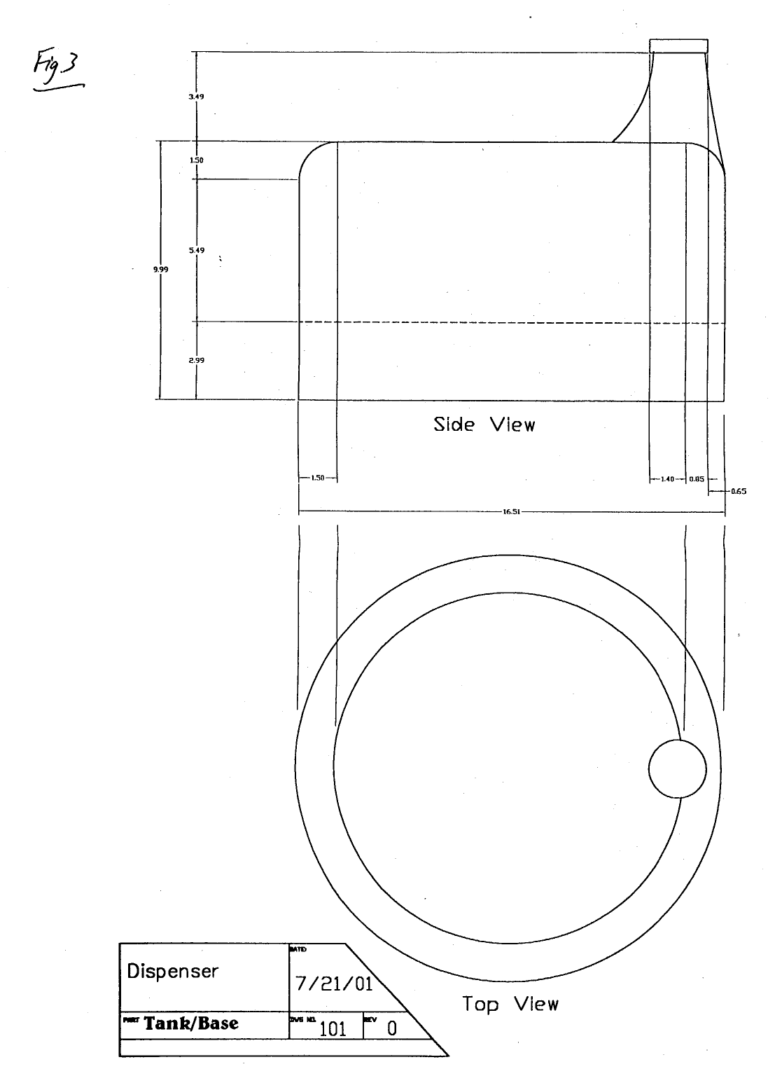

### DETAILED DESCRIPTION OF DRAWINGS

Referring now to the drawings in more detail, the preferred embodiment of the LCID is shown in FIG. ______ and is generally designated by the numeral 10.

The Liquid Chlorine Injection Device (“LCID”) of the preferred embodiment basically comprises a storage vessel for containing the liquid disinfectant, a pumping mechanism, a control mechanism, and some sort of power source. In the preferred embodiment, the pumping mechanism is a positive displacement pump, capable of delivering from approximately one ounce to ten gallons of liquid as necessary. The vessel is an impermeable container for storing liquid disinfectant, with a bottom, a top, and side walls that completely enclose a storage space. Although several locations for the storage vessel relative to the pump tank are possible, typically, it is located atop the pump tank of the relevant sewage treatment plant for convenience. The vessel is constructed of environmentally resistant materials, so that it will resist degradation under the effects of the sun's ultra violet rays, as well as any chemical deterioration caused by the liquid disinfectant stored within the vessel. In the preferred embodiment, the vessel is comprised of fibreglass, and is sized so that it holds a sufficient amount of liquid disinfectant to treat effluent in the pump tank of the relevant sewage treatment plant for several weeks. In the preferred embodiment, the vessel holds approximately two to ten gallons of liquid disinfectant.

Typically, a fill spout with a removable cap is located in the top of the vessel, allowing users to easily pour additional liquid disinfectant into the storage space of the vessel. And in the preferred embodiment, a separate subcompartment is built into the bottom of the vessel, providing a space to house the pumping mechanism. Thus, in the preferred embodiment, the positive displacement pump is located in the subcompartment beneath the bottom floor of the storage space of the vessel, and there is a hole in the bottom floor of the storage space of the vessel (i.e. the top of the subcompartment), allowing the positive displacement pump to draw liquid disinfectant from the storage space of the vessel above, and a hole in the bottom floor of the subcompartment, allowing the positive displacement pump to discharge liquid disinfectant out to the pump tank of the sewage treatment plant being treated. The positive displacement pump is connected appropriately to these holes using tubing in the preferred embodiment. Preferably, the subcompartment is water tight, and the seals on the hole/tubing connection prevent leakage, so that the positive displacement pump is housed in a dry area within the subcompartment.

The control mechanism preferably comprises a computerized control panel operated by software, or some other sort of electronic circuit, and a sensor. The sensor is preferably a time delay circuit, either fixed or variable, that triggers the release of the micro-doses of liquid disinfectant. In the preferred embodiment, the time delay circuit monitors time based upon the run cycle for the pump within the pump tank of the relevant sewage treatment plant. The control mechanism of the preferred embodiment is adjustable. Thus, the length of time that the positive displacement pump is activated and the amount of time between activations may be set appropriately depending upon the factors present in the relevant sewage treatment plant at issue. Upon installation, the control mechanism is set so that, at regular time intervals, it activates the positive displacement pump for the pre-set length of time. Thus, the control mechanism will regularly cause the positive displacement pump to inject a pre-determined amount of liquid disinfectant into the pump tank, and both the interval between injections and the duration/amount of the injections are adjustable, so as to be customizable for each given situation.

The preferred embodiment of LCID uses commonly available household liquid chlorine bleach as the liquid disinfectant of choice. Preferably, the liquid disinfectant is sodium hypochlorite 6% by volume. LCID may also include, as an optional element, a liquid level sensor-alarm for sensing the level of the liquid disinfectant within the vessel of the LCID and activating an alarm that indicates when the vessel needs to be refilled. The preferred embodiment uses two reed switch sensors to accomplish this, typically in conjunction with an audible and/or visual alarm. Each reed switch sensor comprises an integral reed and a magnetic float. When the magnetic float portion of the reed switch sensor is in proximity to the reed portion of the switch, the reed portion will close if the switch is normally open or open if the switch is normally closed. This opening/closing transmits an electronic signal.

The first reed switch sensor, which is the reed switch with the highest elevation in the vessel, is set to sound an alert whenever the level of liquid disinfectant in the vessel of the LCID falls beneath the pre-set low condition mark (typically 10% of the total volume of the vessel). The second reed switch generally is set to indicate that the vessel is completely empty, and that the liquid disinfectant has run out and must be replaced. It also typically deactivates the pump in the pump tank of the sewage treatment plant to which the LCID is attached, ensuring that there is no discharge of dangerous effluent to ground. The second reed switch sensor could also be connected to a central monitoring station, for example by modem, so that if the user employs a monitoring service for a monthly fee, the monitoring service would be notified and could respond as directed under the monitoring plan arrangement.

In the preferred embodiment, the LCID is powered off a standard electrical grid, using 120 volt AC, 50/60 Hz outlet. A battery backup power supply could also be provided, and would probably be needed if the pump for the pump tank of the relevant sewage treatment plant at issue had some sort of backup power source. Also, all sensor connections in the preferred embodiment may be either local or remote, by physical wire, computer, or radio waves.

In the preferred embodiment, the owner of the LCID fills the vessel with liquid chlorine bleach through the spout, replacing the cap upon completion to ensure a closed vessel that completely contains the liquid disinfectant. When the sensor of the control mechanism indicates that additional disinfectant is needed within the pump tank of the sewage treatment plant, the positive displacement pump of the LCID is activated. The positive displacement pump draws in liquid chlorine from the storage area of the vessel and discharges it into the pump tank in micro-doses. As the micro-dosing process occurs, the sensor continues to monitor the chlorine levels within the pump tank. Once the chlorine in the pump tank reaches the appropriate level, the positive displacement pump is deactivated. In the preferred embodiment, the disinfectant injection system of the LCID is governed by a cyclical, time-based process. In that case, the control mechanism senses the time between dosages (i.e. activations of the positive displacement pump) and regularly activates the positive displacement pump for a given duration of time in order to inject the proper amount of liquid disinfectant into the pump tank.

In the preferred embodiment, reed switch sensors in the vessel of the LCID also transmit an alarm to a control panel when the level of liquid chlorine in the vessel falls beneath a minimum level. The first alarm, which has both an audible and visual element and is triggered by the first reed switch, alerts the owner that the vessel needs to be refilled due to a low condition. The second reed switch activates a second alarm, which indicates that the vessel is empty. In the preferred embodiment, the second reed switch also cuts power to the pump for the pump tank of the sewage treatment plant, ensuring that the improperly disinfected effluent is not discharged to ground. It may also transmit a signal to a central monitoring station, requesting service.

The specific embodiments and uses set forth herein are merely illustrative examples of the preferred embodiment of the LCID invention and are not intended to limit the present invention in any way. A person skilled in the field will understand and appreciate additional embodiments and uses, as well as equivalents, which are also included within the scope of the present invention. The scope of the invention is more fully defined in the following claims, and the only limits to the scope of the invention are those set forth explicitly in the claims below.

What we claim is:

1. A liquid disinfectant injection device comprising:
a storage vessel;
a pumping mechanism; and
a control mechanism;
wherein said control mechanism automatically operates said pumping mechanism, and said pumping mechanism draws liquid from said storage vessel for discharge.

2. A liquid disinfectant injection device as in claim 1 wherein:
said control mechanism further comprises a sensor.

3. A liquid disinfectant injection device as in claim 2 wherein said vessel contains liquid disinfectant, and said control mechanism senses whether additional liquid disinfectant is needed and automatically activates said pumping mechanism accordingly.

4. A liquid disinfectant injection device as in claim 3 wherein said sensor further comprises an ultra sonic sensor.

5. A liquid disinfectant injection device as in claim 2 wherein said sensor further comprises a time delay circuit, and wherein said time delay circuit automatically activates said pumping mechanism cyclically.

6. A liquid disinfectant injection device as in claim 1 wherein said vessel further comprises one or more liquid level sensors.

7. A liquid disinfectant injection device as in claim 2 wherein said vessel further comprises one or more liquid level sensors.

8. A liquid disinfectant injection device as in claim 3 wherein said vessel further comprises one or more liquid level sensors.

9. A liquid disinfectant injection device comprising:
a pump tank;
a storage vessel;
a pumping mechanism; and
a control mechanism;
wherein said control mechanism automatically operates said pumping mechanism, and said pumping mechanism draws liquid from said storage vessel for discharge into said pump tank.

10. A liquid disinfectant injection device as in claim 9 wherein:
said control mechanism further comprises a sensor.

11. A liquid disinfectant injection device as in claim 10 wherein said vessel contains liquid disinfectant, and said control mechanism senses whether additional liquid disinfectant is needed within said pump tank and automatically activates said pumping mechanism accordingly.

12. A liquid disinfectant injection device as in claim 10 wherein said sensor further comprises a time delay circuit, and wherein said time delay circuit automatically activates said pumping mechanism cyclically.

13. A liquid disinfectant injection device as in claim 9 wherein said vessel further comprises one or more liquid level sensors.

14. A liquid disinfectant injection device as in claim 10 wherein said vessel further comprises one or more liquid level sensors.

15. A liquid disinfectant injection device as in claim 11 wherein said vessel further comprises one or more liquid level sensors.

16. A liquid disinfectant injection device as in claim 15 wherein said one or more liquid level sensors further comprise two reed switches, and wherein said first reed switch warns that said vessel has entered a low liquid disinfectant level condition, and said second reed switch warns that said vessel is empty.

17. A liquid disinfectant injection device comprising:
liquid disinfectant
a pump tank;
a storage vessel;
a pumping mechanism; and
a control mechanism;
wherein said control mechanism automatically operates said pumping mechanism, and said pumping mechanism draws liquid disinfectant from within said storage vessel for discharge into said pump tank.

18. A liquid disinfectant injection device as in claim 17 wherein:
said control mechanism further comprises a sensor.

19. A liquid disinfectant injection device as in claim 18 wherein said control mechanism senses whether additional liquid disinfectant is needed within said pump tank and automatically activates said pumping mechanism accordingly.

20. A liquid disinfectant injection device as in claim 19 wherein said liquid disinfectant is liquid chlorine.
